(19) United States
(12) Patent Application Publication
(10) Pub. No.: US 2015/0280377 A1
(43) Pub. Date: Oct. 1, 2015

(54) Universal Serial Bus Connector

(71) Applicant: Power Quotient International Co., Ltd., New Taipei City (TW)

(72) Inventor: Chia Hsin Tsai, New Taipei City (TW)

(73) Assignee: Power Quotient International Co., Ltd., New Taipei City (TW)

(21) Appl. No.: 14/230,172

(22) Filed: Mar. 31, 2014

(51) Int. Cl. H01R 24/62; H01R 13/502

(52) U.S. Cl. CPC H01R 24/62; H01R 13/502; H01R 2107/00

(57) ABSTRACT

A USB connector includes an insulating housing, electrical terminals integrated in the insulating housing, a printed circuit board fixed with the insulating housing and the electrical terminals together, a fixed member mounted to the insulating housing and the printed circuit board to integrate the insulating housing, the electrical terminals, the printed circuit board and the fixed member into a basic module, and a shell worn around the basic module. A top face of the fixed member protrudes upward to form a locking block. The shell has a top plate in which a fixing hole is opened. The locking block of the fixed member is buckled in the fixing hole of the top plate. So the USB connector can be easily taken apart almost without damage to facilitate the maintenance work when it is at failure.

### BACKGROUND OF THE INVENTION

1. Field of the Invention

The present application is based on, and claims priority from, Taiwan Patent Application No. 103203068 filed 2014 Feb. 21, the disclosure of which is hereby incorporated by reference herein in its entirety. The present invention relates to an electrical connector, and more particularly to a universal serial bus connector.

2. the Related Art

Along with the development of modern information technology, USB (Universal Serial Bus) connectors are used more and more frequently in electronic products, such as a notebook computer, a mobile phone and so on, for realizing data transmission between the electronic products and corresponding peripheral devices thereof. A conventional USB connector generally includes an insulating housing, a plurality of electrical terminals molded in the insulating housing and each having a welding portion, and a shell fastened around the insulating housing and having a plurality of welding ears. The welding portions of the electrical terminals and the welding ears of the shell are welded on a printed circuit board to fasten the USB connector and the printed circuit board together.

When the USB connector is at failure, it needs to be taken apart for the convenience of the maintenance work. However, because the electrical terminals and the shell are welded with the printed circuit board together, the shell is difficulty taken apart from the printed circuit board. Moreover, the shell and the insulating housing are fastened together so that easily causes a damage in the process of taking the shell apart from the insulating housing. As a result, the USB connector and the printed circuit board are apt to be damaged in the maintenance work, and the USB connector together with the printed circuit board can but be entirely replaced. So a USB connector capable of overcoming the foregoing problems is required.

### SUMMARY OF THE INVENTION

Accordingly, an object of the present invention is to provide a USB connector. The USB connector includes an insulating housing, a plurality of electrical terminals, a printed circuit board, a fixed member and a shell. The electrical terminals are integrated in the insulating housing, and each electrical terminal has a welding portion projecting behind the insulating housing. The insulating housing and the welding portions of the electrical terminals are fixed on a front of the printed circuit board. A top face of the fixed member protrudes upward to form a locking block. The fixed member is mounted to a rear end of the insulating housing and the printed circuit board and covers on the welding portions of the electrical terminals and a rear of the printed circuit board to integrate the insulating housing, the electrical terminals, the printed circuit board and the fixed member into a basic module. The shell has a top plate, a bottom plate and two side plates which together show a tubular shape. The top plate defines a fixing hole which is opened in the rear thereof and communicates with the interior of the shell. The shell is worn around the basic module and the locking block of the fixed member is buckled in the fixing hole of the top plate.

As described above, the printed circuit board is only fixed with the insulating housing and the electrical terminals together, and then the insulating housing together with the printed circuit board are assembled in the shell by virtue of the fixed member. Therefore, the USB connector can be easily taken apart almost without damage to facilitate the maintenance work when it is at failure.

### BRIEF DESCRIPTION OF THE DRAWINGS

The present invention will be apparent to those skilled in the art by reading the following description thereof, with reference to the attached drawings, in which:

FIG. 1 is a perspective view of a USB connector according to an embodiment of the present invention;

FIG. 2 is an exploded view of the USB connector of FIG. 1;

FIG. 3 is a perspective view of the USB connector without a shell of FIG. 1; and

FIG. 4 is a perspective view of a fixed member of the USB connector of FIG. 2.

### DETAILED DESCRIPTION OF THE EMBODIMENT

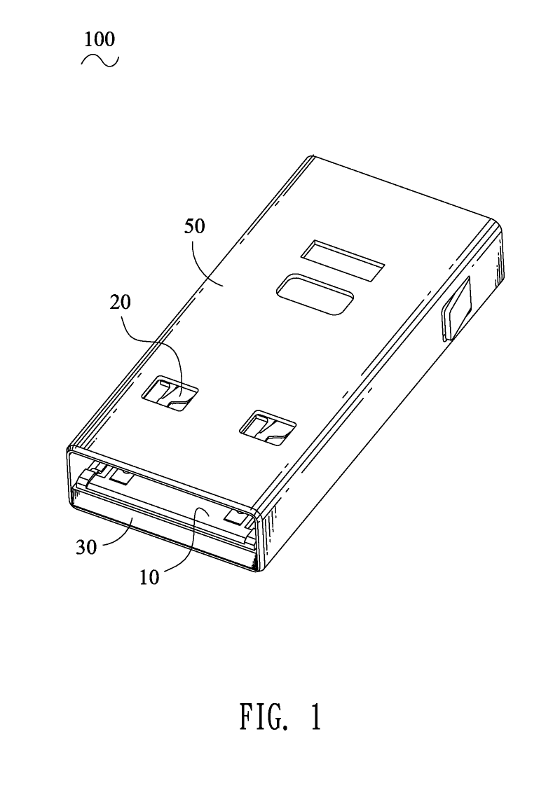

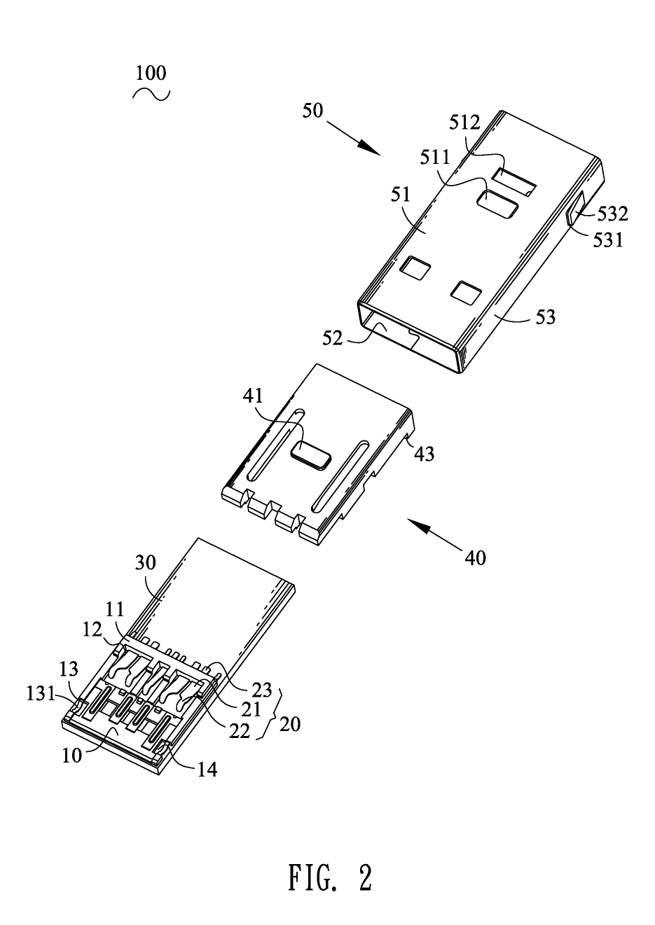

With reference to FIG. 1 and FIG. 2, an embodiment of the invention is embodied in a USB connector 100. The USB connector 100 includes an insulating housing 10, a plurality of electrical terminals 20, a printed circuit board 30, a fixed member 40 and a shell 50.

A rear end of the insulating housing 10 protrudes upward to form a retaining wall 11 of substantial lying-U shape of which the mouth faces a front end of the insulating housing 10. A top face of the insulating housing 10 defines a plurality of grooves 12 arranged transversely at regular intervals and surrounded in the retaining wall 11. Front ends of two opposite side edges of the insulating housing 10 define two gaps 14 vertically penetrating through the insulating housing 10. The insulating housing 10 is further integrated with a pair of fixed terminals 13 in the two opposite side edges of the insulating housing 10. A substantial middle part of each fixed terminal 13 located in the corresponding gap 14 of the insulating housing 10 is arched downward to form a welding section 131 welded on the printed circuit board 30 through the gap 14.

Referring to FIG. 2, the electrical terminals 20 are integrated in the insulating housing 10. Each electrical terminal 20 has a welding portion 23 projecting behind the insulating housing 10. In detail, each electrical terminal 20 has a board-shaped fastening portion 21 integrated in the rear end of the insulating housing 10 and a contact portion 22 extending forward and upward from a front end of the fastening portion 21. The contact portion 22 is elastically received in the groove 12 of the insulating housing 10. The welding portion 23 is formed by a rear end of the fastening portion 21 being bent downward and then extending rearward. The welding portion 23 is welded on the printed circuit board 30.

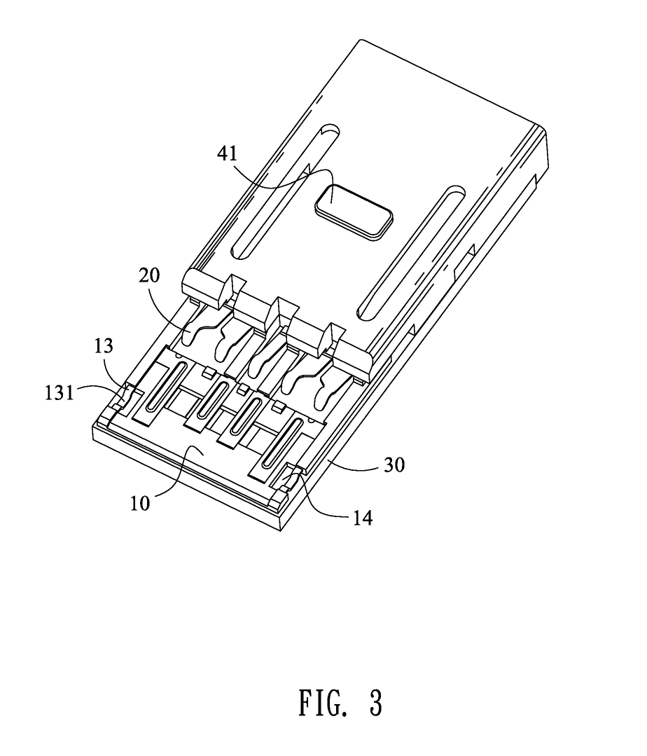

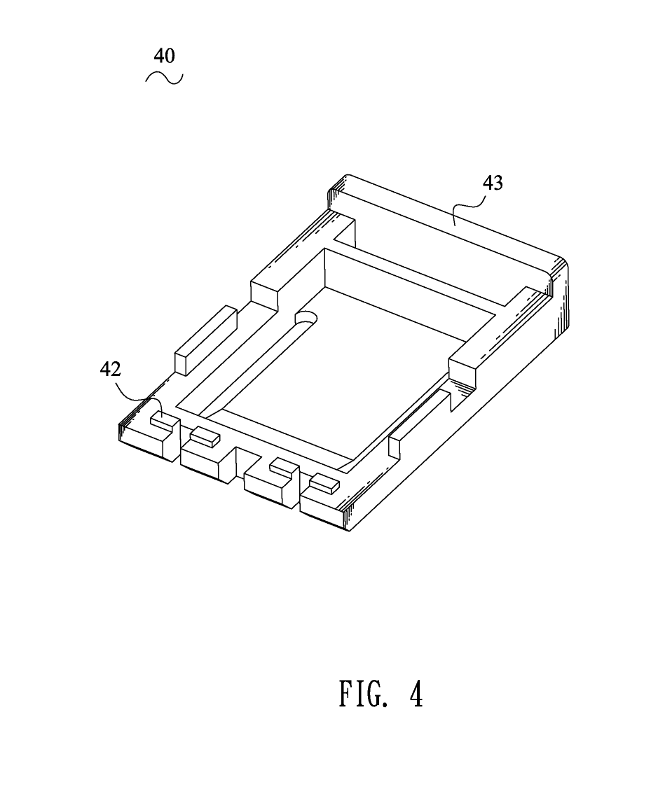

Referring to FIG. 2, FIG. 3 and FIG. 4, a top face of the fixed member 40 protrudes upward to form a locking block 41. A bottom face of the fixed member 40 protrudes downward to form a plurality of buckling blocks 42 arranged transversely at regular intervals in the front thereof and a resisting wall 43 extending transversely in the rear thereof. In this embodiment of the invention, the fixed member 40 is made of plastic material.

The shell 50 has a top plate 51, a bottom plate 52 and two side plates 53 which together show a tubular shape. The top plate 51 defines a fixing hole 511 which is opened in the rear thereof and communicates with the interior of the shell 50. In order to facilitate the USB 100 to be installed on a product (not shown), the top plate 51 of the shell 50 further defines a mounting hole 512 arranged behind the fixing hole 511, and a rear of each of the side plates 53 is opened with a through hole 531 of which a rear edge extends forward and is inclined outward to form a buckling slice 532. In this embodiment of the invention, the shell 50 is made of metal material.

Referring to FIG. 1, FIG. 2, FIG. 3 and FIG. 4, the insulating housing 10 together with the electrical terminals 20 are fixed on a front of the printed circuit board 30 by virtue of the welding sections 131 of the fixed terminals 13 and the welding portion 23 of the electrical terminals 20 being welded on the printed circuit board 30. The fixed member 40 is mounted to the rear end of the insulating housing 10 and the printed circuit board 30, and covers on the welding portions 23 of the electrical terminals 20 and a rear of the printed circuit board 30 from the top-to-bottom direction to integrate the insulating housing 10, the electrical terminals 20, the printed circuit board 30 and the fixed member 40 into a basic module. The buckling blocks 42 of the fixed member 40 are buckled against a front side of the retaining wall 11 of the insulating housing 10, and the resisting wall 43 of the fixed member 40 resists against a back side of the printed circuit board 30. At last, the shell 50 is worn around the basic module and the locking block 41 of the fixed member 40 is buckled in the fixing hole 511 of the top plate 51.

As described above, the printed circuit board 30 is only fixed with the insulating housing 10 and the electrical terminals 20 together, and then the insulating housing 10 together with the printed circuit board 30 are assembled in the shell 50 by virtue of the fixed member 40. Therefore, the USB connector 100 is easily taken apart almost without damage to facilitate the maintenance work when it is at failure.

What is claimed is:

1. A USB connector, comprising:
an insulating housing;
a plurality of electrical terminals integrated in the insulating housing, each electrical terminal having a welding portion projecting behind the insulating housing;
a printed circuit board, the insulating housing and the welding portions of the electrical terminals being fixed on a front of the printed circuit board;
a fixed member of which a top face protrudes upward to form a locking block, the fixed member being mounted to a rear end of the insulating housing and the printed circuit board and covering on the welding portions of the electrical terminals and a rear of the printed circuit board to integrate the insulating housing, the electrical terminals, the printed circuit board and the fixed member into a basic module; and
a shell having a top plate, a bottom plate and two side plates which together show a tubular shape, the top plate defining a fixing hole which is opened in the rear thereof and communicates with the interior of the shell, the shell being worn around the basic module and the locking block of the fixed member being buckled in the fixing hole of the top plate.

2. The USB connector as claimed in claim 1, wherein the rear end of the insulating housing protrudes upward to form a retaining wall of substantial lying-U shape of which the mouth faces a front end of the insulating housing, a bottom face of the fixed member protrudes downward to form a plurality of buckling blocks arranged transversely at regular intervals in the front thereof and a resisting wall extending transversely in the rear thereof, the buckling blocks of the fixed member are buckled against a front side of the retaining wall of the insulating housing, and the resisting wall of the fixed member resists against a back side of the printed circuit board.

3. The USB connector as claimed in claim 2, wherein a top face of the insulating housing defines a plurality of grooves arranged transversely at regular intervals and surrounded in the retaining wall, each electrical terminal further has a fastening portion integrated in the rear end of the insulating housing and a contact portion extending forward and upward from a front end of the fastening portion, the contact portion is elastically received in the groove of the insulating housing, the welding portion is formed by a rear end of the fastening portion being bent downward and then extending rearward.

4. The USB connector as claimed in claim 1, wherein front ends of two opposite side edges of the insulating housing define two gaps vertically penetrating through the insulating housing, the insulating housing is further integrated with a pair of fixed terminals in the two opposite side edges of the insulating housing, a substantial middle part of each fixed terminal located in the corresponding gap of the insulating housing is arched downward to form a welding section welded on the printed circuit board through the gap.

5. The USB connector as claimed in claim 1, wherein the top plate of the shell further defines a mounting hole arranged behind the fixing hole, a rear of each of the side plates is opened with a through hole of which a rear edge extends forward and is inclined outward to form a buckling slice.

6. The USB connector as claimed in claim 1, wherein the fixed member is made of plastic material.

7. The USB connector as claimed in claim 1, wherein the shell is made of metal material.
